(19) United States
(12) Patent Application Publication
(10) Pub. No.: US 2006/0152175 A1
(43) Pub. Date: Jul. 13, 2006

(54) Single led driver for a traffic light

(75) Inventor: Bernd Clauberg, Schaumburg, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/562,511

(22) PCT Filed: Jun. 21, 2004
(86) PCT No.: PCT/IB04/02056

§ 371 Date: Dec. 28, 2005

Related U.S. Application Data
(60) Provisional application No. 60/483,777, filed on Jun. 30, 2003.

(51) Int. Cl. H05B 39/00

(52) U.S. Cl. 315/312

(57) ABSTRACT

One form of a traffic light (10, 11) employs one or more LED circuits connected to a voltage source (V_{S}). Each LED circuit includes a series connection of a LED array (30), a current limiter (31) and an electronic switch (32). Each current limiter (31) controls a flow of LED current (I_{RL}) through an associated LED array (30) whenever a switch controller (21) closes the associated electronic switch (32). Another form of a traffic light (60, 61) employs one or more LED circuits connected to a current source (I_{S}). Each LED circuit includes a parallel connection of a LED array (80) and an electronic switch (81). A LED current (I_{RL}) flows through an LED array (80) whenever a switch controller (71) opens the associated electronic switch (81).

The present invention generally relates to light emitting diodes (“LEDs”). The present invention specifically relates to a single driver operating multiple LEDs in a traffic light located at a road intersection, a railroad crossing, a movable bridge and any other well known implementation of a traffic light.

Semiconductor light sources such as LEDs are increasingly used in traffic lights. A semiconductor light source in such an application has the advantage over a usual incandescent lamp in that it has a longer life and a lower power consumption than the incandescent lamp. Traffic lights used to direct traffic at road intersections typically have three LED arrays where the color of the emitted optical power from the LED arrays is red, yellow and green, respectively. An LED array will generally be formed from 12 to 250 individual LEDs and the total optical output power of the LED array is about 1 Watt. Each LED array is controlled by a unique LED driver. It is desirable to reduce overall system costs by reducing the number of LED drivers.

One form of the present invention is a traffic light comprising a voltage source, a switch controller, and a LED circuit coupled in parallel to the voltage source. The LED circuit includes a series connection of an LED array, a current limiter, and an electronic switch. A flow of LED current from the voltage source through the LED array is impeded whenever the switch controller opens the electronic switch. The current limiter controls a flow of the LED current through the LED array whenever the switch controller closes the electronic switch. The switch controller selectively opens and closes the electronic switch to thereby selectively emit a traffic light from the LED array.

A second form of the present invention is a traffic light comprising a current source, a switch controller, and a LED circuit coupled in series to the current source. The LED circuit includes a parallel connection of an LED array and an electronic switch. A flow of LED current from the current source through the LED array is impeded whenever the switch controller closes the electronic switch. The LED current flows from the current source through the LED array whenever the switch controller opens the electronic switch. The switch controller selectively opens and closes the electronic switch to thereby selectively emit a traffic light from the LED circuit.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

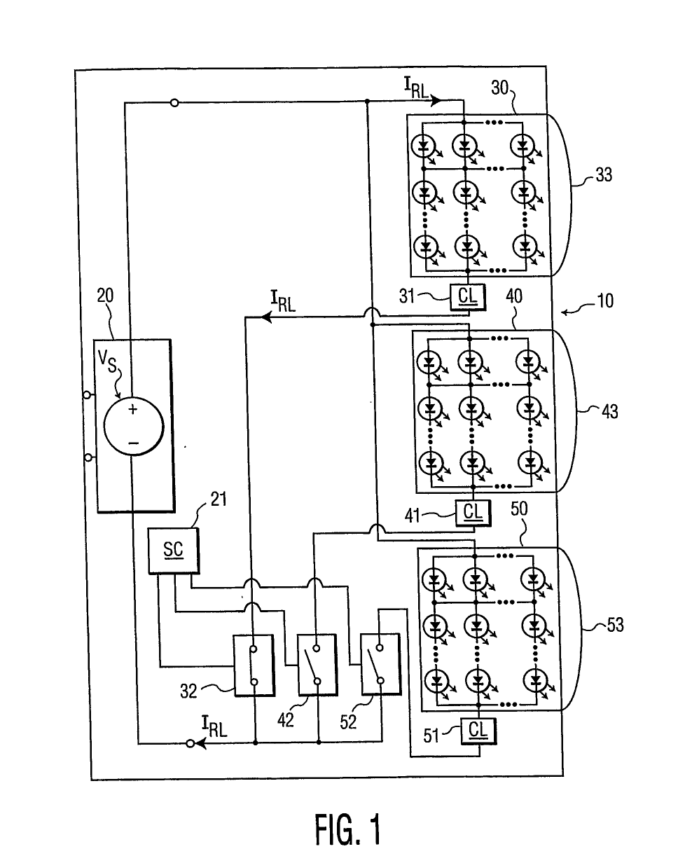

FIG. 1 illustrates a first embodiment in accordance with the present invention of a traffic light emitting a red light;

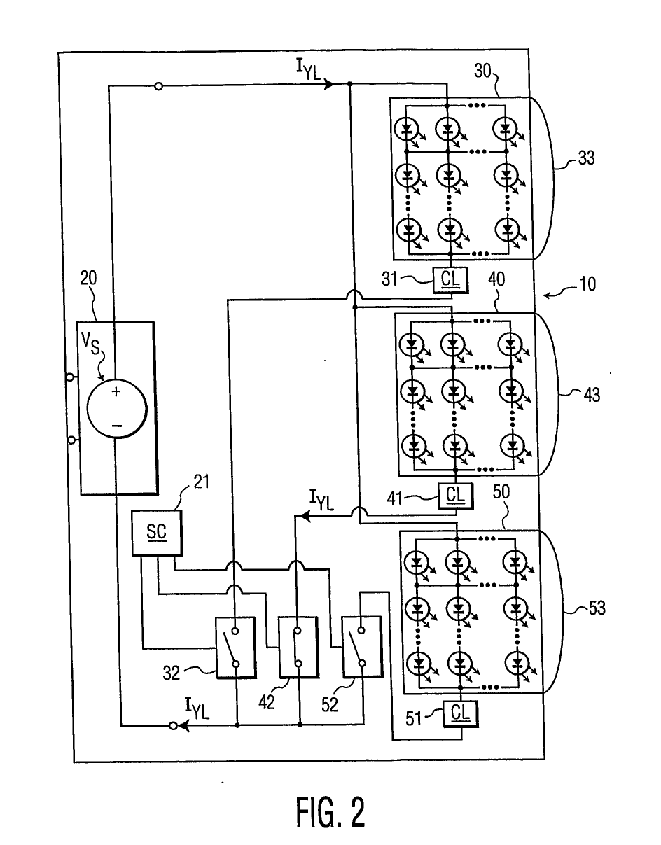

FIG. 2 illustrates the FIG. 1 traffic light emitting a yellow light;

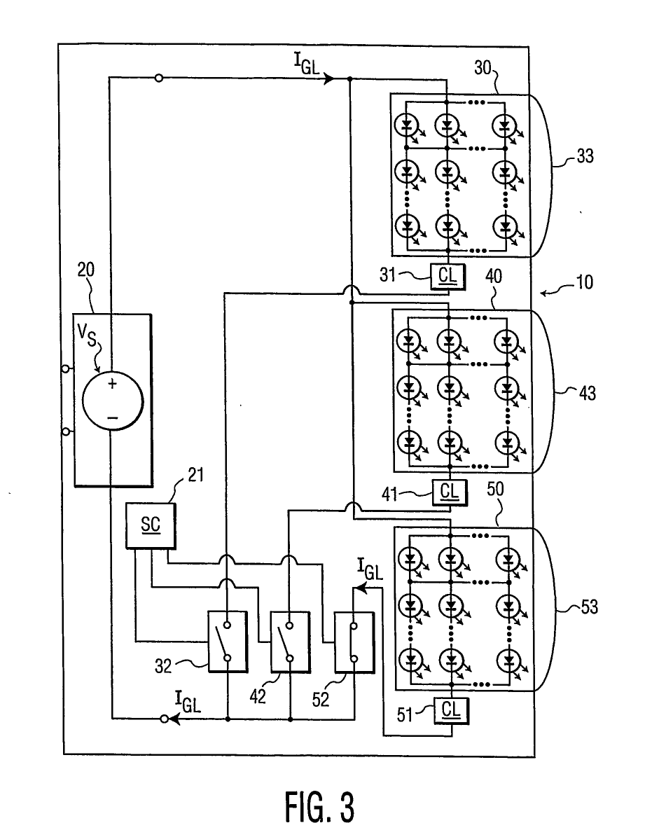

FIG. 3 illustrates the FIG. 1 traffic light emitting a green light;

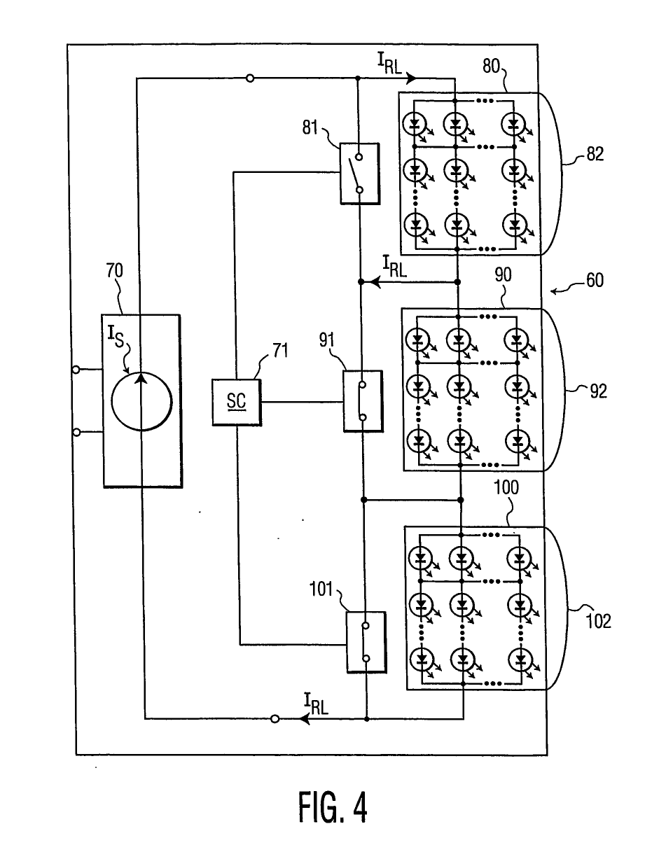

FIG. 4 illustrates a second embodiment in accordance with the present invention of a traffic light emitting a red light;

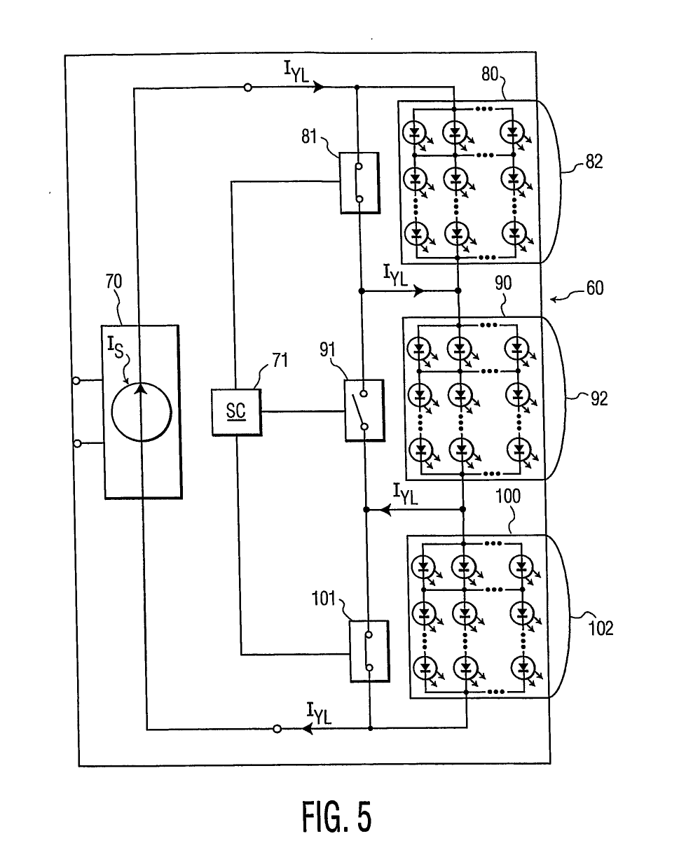

FIG. 5 illustrates the FIG. 4 traffic light emitting a yellow light;

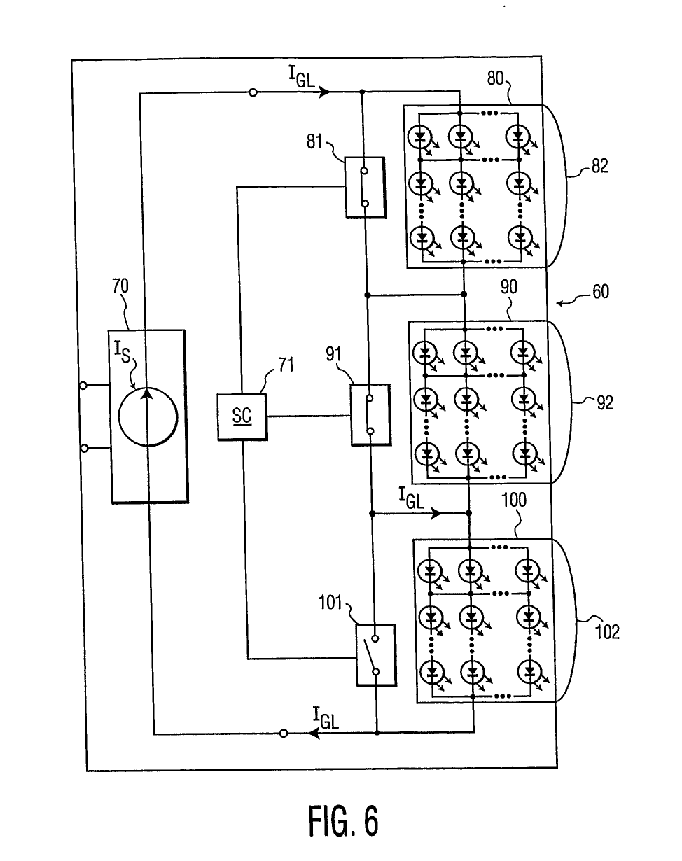

FIG. 6 illustrates the FIG. 4 traffic light emitting a green light;

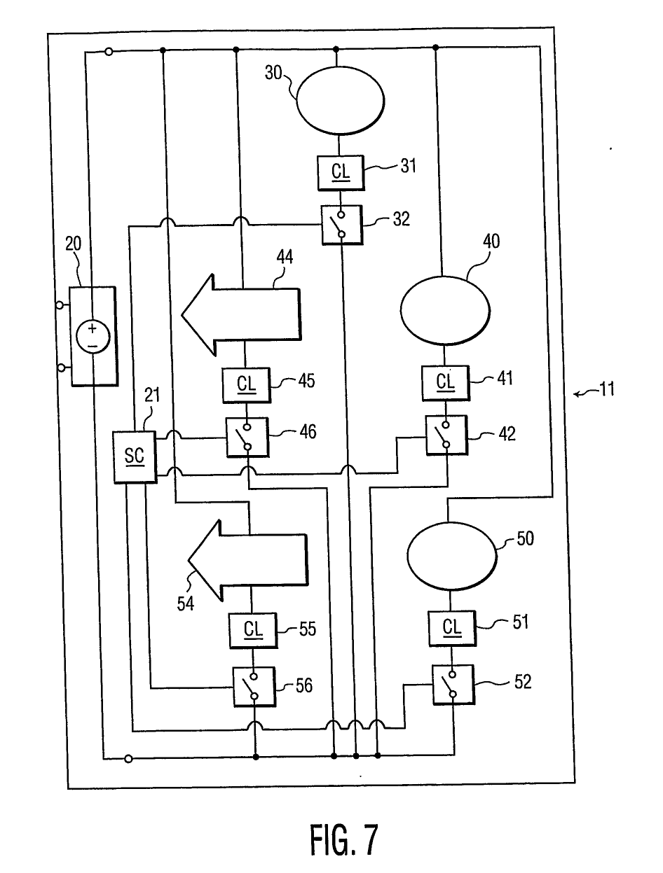

FIG. 7 illustrates a third embodiment in accordance with the present invention of a traffic light; and

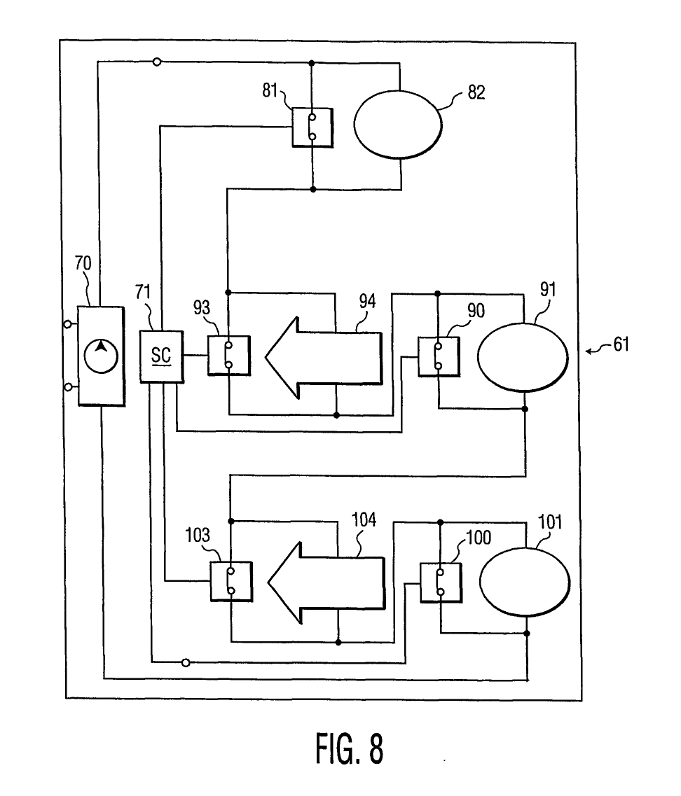

FIG. 8 illustrates a fourth embodiment in accordance with the present invention of a traffic light.

A traffic light 10 illustrated in FIGS. 1-3 employs an LED driver 20, a switch controller (“SC”) 21, a red LED circuit connected in parallel to LED driver 20, a yellow LED circuit connected in parallel to LED driver 20, and a green LED circuit connected in parallel to LED driver 20. LED driver 20 employs a voltage source V_{S} to provide LED currents to the LED circuits as will be subsequently described herein. In practice, voltage source V_{S} will typically be 120 V for the United States while for other markets, such as Europe and Asia, voltage source V_{S} may be 230 V to 240 V.

The red LED circuit employs a series connection of an R-LED array 30, a conventional current limiter (“CL”) 31 and a conventional electronic switch 32. A conventional refractor 33 is situated relative to R-LED array 30 to communicate a red traffic signal whenever any light is emitted from R-LED array 30. In one embodiment, R-LED array 30 emits white light and a color of refractor 33 is red. In a second embodiment, R-LED array 30 emits red light and a color of refractor 33 is red.

The yellow LED circuit employs a series connection of an Y-LED array 40, a conventional current limiter (“CL”) 41 and a conventional electronic switch 42. A conventional refractor 43 is situated relative to Y-LED array 40 to communicate a yellow traffic signal whenever any light is emitted from Y-LED array 40. In one embodiment, Y-LED array 40 emits white light and a color of refractor 33 is yellow. In a second embodiment, Y-LED array 40 emits yellow light and a color of refractor 33 is yellow.

The green LED circuit employs a series connection of an G-LED array 50, a conventional current limiter (“CL”) 51 and a conventional electronic switch 52. A conventional refractor 53 is situated relative to G-LED array 50 to communicate a green traffic signal whenever any light is emitted from G-LED array 50. In one embodiment, G-LED array 50 emits white light and a color of refractor 33 is green. In a second embodiment, G-LED array 50 emits green light and a color of refractor 33 is green.

Switch controller 21 is conventionally operated to selectively open and close switches 32, 42 and 52 in a manner to allow light to be emitted from only one of the LED arrays 30, 40 or 50 for a given time period.

In a red light operation as illustrated in FIG. 1, switch 32 is closed, and switches 42 and 52 are open. As a result, only the red LED circuit will have a LED current I_{RL} flowing through it to thereby emit a red traffic light via R-LED array 30 and refractor 33.

In a yellow light operation as illustrated in FIG. 2, switch 42 is closed, and switches 32 and 52 are open. As a result, only the yellow LED circuit will have a LED current I_{YL} flowing through it to thereby emit a yellow traffic light via Y-LED array 40 and refractor 43.

In a green light operation as illustrated in FIG. 3, switch 52 is closed, and switches 32 and 42 are open. As a result, only the green LED circuit will have a LED current I_{GL} flowing through it to thereby emit a green traffic light via G-LED array 50 and refractor 53.

Switch controller 21 is in electric communication with a traffic controller unit (not shown), which will instruct the switch controller 21 when each switch 32, 42 and 52 is to be exclusively closed. A properly operating switch controller 21 will never simultaneously close two of the switches 32, 42 and 52 of traffic signal 10 in order to avoid sending a conflicting communication to an observer.

FIGS. 4-6 illustrate a traffic light 60 employing an LED driver 70, a switch controller (“SC”) 71, a red LED circuit connected in series to LED driver 70, a yellow LED circuit connected in series to the red LED circuit, and a green LED circuit connected in series to the yellow LED circuit. LED driver 70 includes a current source I_{S} to provide LED currents to the LED circuits as subsequently described herein.

The red LED circuit employs a parallel connection of an R-LED array 80 and a conventional electronic switch 81. A conventional refractor 82 is situated relative to R-LED array 80 to communicate a red traffic signal whenever any light is emitted from R-LED array 80. In one embodiment, R-LED array 80 emits white light and a color of refractor 83 is red. In a second embodiment, R-LED array 80 emits red light and a color of refractor 83 is red.

The yellow LED circuit employs a parallel connection of an Y-LED array 90 and a conventional electronic switch 91. A conventional refractor 92 is situated relative to Y-LED array 90 to communicate a yellow traffic signal whenever any light is emitted from Y-LED array 90. In one embodiment, Y-LED array 90 emits white light and a color of refractor 93 is yellow. In a second embodiment, Y-LED array 90 emits yellow light and a color of refractor 93 is yellow.

The green LED circuit employs a parallel connection of an G-LED array 100 and a conventional electronic switch 101. A conventional refractor 102 is situated relative to G-LED array 100 to communicate a green traffic signal whenever any light is emitted from G-LED array 100. In one embodiment, G-LED array 100 emits white light and a color of refractor 103 is green. In a second embodiment, G-LED array 100 emits green light and a color of refractor 33 is green.

Switch controller 71 is conventionally operated to selectively open and close switches 81, 91 and 101 in a manner to allow light to be emitted from only one of the LED arrays 80, 90 or 100 for a given time period.

In a red light operation as illustrated in FIG. 4, switch 81 is open, and switches 91 and 101 are closed. As a result, LED current I_{RL} will first flow through the R-LED array 80 to thereby emit a red traffic light via R-LED array 80 and refractor 82, and then flow through the short circuits parallel to the LED arrays 90 and 100 formed by closed switches 91 and 100, respectively.

In a yellow light operation as illustrated in FIG. 5, switch 91 is open, and switches 81 and 101 are closed. As a result, LED current I_{YL} will subsequently flow through (1) the short circuit parallel to the R-LED array 80 formed by closed switch 81, (2) Y-LED array 90 to thereby emit a yellow traffic signal via Y-LED array 90 and refractor 92, and (3) the short circuit parallel to G-LED array 100 formed by closed switch 101.

In a green light operation as illustrated in FIG. 6, switch 101 is open, and switches 81 and 91 are closed. As a result, LED current I_{GL} will first flow through the short circuits parallel to the LED arrays 80 and 90 formed by closed switches 81 and 91, respectively, and flow through G-LED array 100 to thereby emit a green traffic signal via G-LED array 100 and refractor 102.

Switch controller 71 is in communication with a traffic controller unit (not shown), which instructs switch controller 71 when the switches 81, 91 and 101 are to be exclusively opened. A properly operating switch controller 71 will never simultaneously open two of the switches 81, 91 and 101 of traffic signal 60 in order to avoid sending a conflicting communication to an observer.

A traffic light 11 illustrated in FIG. 7 employs LED driver 20, switch controller (“SC”) 21, a red LED circuit connected in parallel to LED driver 20, two (2) yellow LED circuits connected in parallel to LED driver 20, and two (2) green LED circuit connected in parallel to LED driver 20.

The red LED circuit employs a series connection of R-LED array 30, current limiter (“CL”) 31 and conventional electronic switch 32 as previously described in connection with the description of FIGS. 1-3.

The right side yellow LED circuit employs a series connection of Y-LED array 40, current limiter (“CL”) 41 and electronic switch 42 as previously described in connection with the description of FIGS. 1-3. Analogous to the right side yellow LED circuit, the left side yellow LED circuit employs a series of connection of a Y-LED array 44, a conventional current limiter (“CL”) 45, and a conventional electronic switch 46.

The right side green LED circuit employs a series connection of LED array 50, current limiter (“CL”) 51 and electronic switch 52 as previously described in connection with the description of FIGS. 1-3. Analogous to the right side green LED circuit, the left side green LED circuit employs a series connection of a G-LED array 54, a conventional current limiter (“CL”) 55, and a conventional electronic switch 56.

Switch controller 21 is conventionally operated to selectively open and close electronic switches 32, 42, 45, 52 and 56 in a manner to allow light to be emitted from one or two of the LED arrays 30, 40, 44, 50 and 54 for a specified time period. Those having ordinary skill in the art will appreciate the nature of various LED currents selectively flowing through LED arrays 30, 40, 44, 50 and 54 based on the selective opening and closing of electronic switches 32, 42, 45, 52 and 56.

A traffic light 61 illustrated in FIG. 8 employs LED driver 70, switch controller (“SC”) 71, a red LED circuit connected in series to LED driver 70, a series connection of (2) yellow LED circuits to the red LED circuit, and a series connection of two (2) green LED circuits to said yellow LED circuits.

The red LED circuit employs a parallel connection of R-LED array 80 and electronic switch 81 as previously described in connection with the description of FIGS. 4-6.

The right side yellow LED circuit employs a parallel connection of Y-LED array 90, electronic switch 92 as previously described in connection with the description of FIGS. 4-6. Analogous to the right side yellow LED circuit, the left side yellow LED circuit employs a parallel connection of a Y-LED array 93 and a conventional electronic switch 95.

The right side green LED circuit employs a parallel connection of LED array 100 and electronic switch 101 as previously described in connection with the description of FIGS. 4-6. Analogous to the right side green LED circuit, the left side green LED circuit employs a parallel connection of a G-LED array 103 and a conventional electronic switch 104.

Switch controller 71 is conventionally operated to selectively open and close electronic switches 81, 91, 94, 101 and 104 in a manner to allow light to be emitted from one or two of the LED arrays 80, 90, 93, 100 and 103 for a specified time period. Those having ordinary skill in the art will appreciate the nature of various LED currents selectively flowing through LED arrays 80, 90, 93, 100 and 103 based on the selective opening and closing of electronic switches 81, 91, 94, 101 and 104.

Those having ordinary skill in the art will appreciate numerous and various implementations of a traffic light in accordance with the present invention as described herein. A first exemplary implementation is as a standard traffic light that is used at an intersection of crossroads to prevent vehicular collisions at the intersection. A second exemplary implementation is as a traffic light that signals when a movable bridge is inactive or active. A third exemplary implementation is as a traffic light that controls two flashing red lights at a railroad crossing. A fourth exemplary implementation is a traffic light that controls an oscillating signaling of “Walk” and “Don't Walk” at an intersection. A fifth exemplary implementation is as a flashing traffic light signaling drivers to merge from two lanes into one lane.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

1. A traffic light (10, 11), comprising:
a voltage source (V_{S});
a first LED circuit including a series connection of a first LED array (30), a first current limiter (31) and a first electronic switch (32) to said voltage source (V_{S}); and
a switch controller (21) operable to selectively open and close said first electronic switch (32),
wherein said first current limiter (31) controls a flow of a first LED current (I_{RL}) from said voltage source (V_{S}) through said first LED array (30) whenever said switch controller (21) closes said first electronic switch (32), and
wherein the flow of the first LED current (I_{RL}) from said voltage source (V_{S}) through said first LED array (30) is impeded whenever said switch controller (21) opens said first electronic switch (32).

2. The traffic light (10, 11) of claim 1, further comprising:
a second LED circuit connected in parallel to said first LED circuit, said second LED circuit including a series connection of a second LED array (40), a second current limiter (41) and a second electronic switch (42) to said voltage source (V_{S}),
wherein said switch controller (21) is further operable to selectively open and close said second electronic switch (42),
wherein said second current limiter (41) controls a flow of a second LED current (I_{YL}) from said voltage source (V_{S}) through said second LED array (40) whenever said switch controller (21) closes said second electronic switch (42), and
wherein the flow of the second LED current (I_{YL}) from said voltage source (V_{S}) through said second LED array (40) is impeded whenever said switch controller (21) opens said second electronic switch (42).

3. The traffic light (10, 11) of claim 2, further comprising:
a third LED circuit connected in parallel to said first LED circuit and said second LED circuit, said third LED circuit including a series connection of a third LED array (50), a third current limiter (51) and a third electronic switch (52) to said voltage source (V_{S}),
wherein said switch controller (21) is further operable to selectively open and close said third electronic switch (52),
wherein said third current limiter (51) controls a flow of a third LED current (I_{GL}) from said voltage source (V_{S}) through said third LED array (50) whenever said switch controller (21) closes said third electronic switch (52), and
wherein the flow of the third LED current (I_{GL}) from said voltage source (V_{S}) through said third LED array (50) is impeded whenever said switch controller (21) opens said third electronic switch (52).

4. The traffic light (10, 11) of claim 3, further comprising:
a fourth LED circuit connected in parallel to said first LED circuit, said second LED circuit and said third LED circuit, said fourth LED circuit including a series connection of a fourth LED array (44), a fourth current limiter (45) and a fourth electronic switch (46) to said voltage source (V_{S}),
wherein said switch controller (21) is further operable to selectively open and close said fourth electronic switch (46),
wherein said fourth current limiter (45) controls a flow of a fourth LED current from said voltage source (V_{S}) through said fourth LED array (44) whenever said switch controller (21) closes said fourth electronic switch (46), and
wherein the flow of the fourth LED current from said voltage source (V_{S}) through said fourth LED array (44) is impeded whenever said switch controller (21) opens said fourth electronic switch (46).

5. The traffic light (10, 11) of claim 4, further comprising:
a fifth LED circuit connected in parallel to said first LED circuit, said second LED circuit, said third LED circuit and said fourth LED circuit, said fifth LED circuit including a series connection of a fifth LED array (54), a fifth current limiter (55) and a fifth electronic switch (56) to said voltage source (V_{S}),
wherein said switch controller (21) is further operable to selectively open and close said fifth electronic switch (56),
wherein said fifth current limiter (55) controls a flow of a fifth LED current from said voltage source (V_{S}) through said fifth LED array (54) whenever said switch controller (21) closes said fifth electronic switch (56), and
wherein the flow of the fifth LED current from said voltage source (V_{S}) through said fifth LED array (54) is impeded whenever said switch controller (21) opens said fifth electronic switch (56).

6. A traffic light (60, 61), comprising:
a current source (I_{S});
a first LED circuit connected in series to said current source (I_{S}), said first LED circuit including a parallel connection of a first LED array (80) and a first electronic switch (81); and
a switch controller (71) operable to selectively open and close said first electronic switch (81),
wherein a first LED current (I_{RL}) flows from said current source (I_{S}) through said first LED array (80) whenever said switch controller (71) opens said first electronic switch (81), and
wherein the flow of the first LED current (I_{RL}) from said current source (I_{S}) through said first LED array (80) is impeded whenever said switch controller (71) closes said first electronic switch (81).

7. The traffic light (60, 61) of claim 6, further comprising:
a second LED circuit connected in series to said second LED circuit, said second LED circuit including a parallel connection of a second LED array (90) and a second electronic switch (91),
wherein said switch controller (71) is further operable to selectively open and close said second electronic switch (91),
wherein a second LED current (I_{YL}) flows from said current source (I_{S}) through said second LED array (90) whenever said switch controller (71) opens said second electronic switch (91), and
wherein the flow of the second LED current (I_{YL}) from said current source (I_{S}) through said second LED array (90) is impeded whenever said switch controller (71) closes said second electronic switch (91).

8. The traffic light (60, 61) of claim 7, further comprising:
a third LED circuit connected in series to said second LED circuit, said third LED circuit including a parallel connection of a third LED array (100) and a third electronic switch (101),
wherein said switch controller (71) is further operable to selectively open and close said third electronic switch (101),
wherein a third LED current (I_{GL}) flows from said current source (I_{S}) through said third LED array (100) whenever said switch controller (71) opens said third electronic switch (101), and
wherein the flow of the third LED current (I_{GL}) from said current source (I_{S}) through said third LED array (100) is impeded whenever said switch controller (71) closes said third electronic switch (101).

9. The traffic light (60, 61) of claim 8, further comprising:
a fourth LED circuit connected in series to said fourth LED circuit, said fourth LED circuit including a parallel connection of a fourth LED array (93) and a fourth electronic switch (94),
wherein said switch controller (71) is further operable to selectively open and close said fourth electronic switch (94),
wherein a fourth LED current flows from said current source (I_{S}) through said fourth LED array (93) whenever said switch controller (71) opens said fourth electronic switch (94), and
wherein the flow of the fourth LED current from said current source (I_{S}) through said fourth LED array (93) is impeded whenever said switch controller (71) closes said fourth electronic switch (94).

10. The traffic light (60, 61) of claim 9, further comprising:
a fifth LED circuit connected in series to said fifth LED circuit, said fifth LED circuit including a parallel connection of a fifth LED array (103) and a fifth electronic switch (104),
wherein said switch controller (71) is further operable to selectively open and close said fifth electronic switch (104),
wherein a fifth LED current flows from said current source (I_{S}) through said fifth LED array (103) whenever said switch controller (71) opens said fifth electronic switch (104), and
wherein the flow of the fifth LED current from said current source (I_{S}) through said fifth LED array (103) is impeded whenever said switch controller (71) closes said fifth electronic switch (104).
